(19) United States
(12) Patent Application Publication
(10) Pub. No.: US 2014/0370308 A1
(43) Pub. Date: Dec. 18, 2014

(54) LAMINATE FILM FOR ATTACHING TO A WINDOW, AND A MANUFACTURING METHOD THEREOF AND AN APPLYING METHOD THEREOF

(71) Applicant: 3M INNOVATIVE PROPERTIES COMPANY, St. Paul, MN (US)

(72) Inventor: Shigeyoshi Ishii, Hatiouji-city (JP)

(21) Appl. No.: 14/368,250

(22) PCT Filed: Dec. 20, 2012
(86) PCT No.: PCT/US2012/071080

§ 371 Date: Jun. 23, 2014

(30) Foreign Application Priority Data
Dec. 27, 2011 (JP) 2011-286662

(51) Int. Cl. E06B 3/30; B32B 25/20; B32B 37/18; B32B 25/08

(52) U.S. Cl. CPC E06B 3/30; B32B 25/08; B32B 25/20; B32B 37/182
USPC 428/447; 156/60

(57) ABSTRACT

A window adhesion laminated layer film includes a plastic film layer, a silicone rubber layer and an excess adhesion relief layer that is on the surface of the above described silicone rubber layer. A method of manufacturing such a window adhesion laminated layer film and an application method are also described.

### BACKGROUND

The present disclosure relates to a laminated layer film comprising a plastic film layer, a silicone rubber layer adhering to glass, acrylic etc., windows, and an excess adhesion relief layer, and to a manufacturing method and its application method.

On building windows etc., films adhering to these windows are used with the goal to shelter from sunlight and to prevent glass shattering. Most recently there are window adhesion films that contain an adhesive agent with the goal that they are able to shelter from the infrared rays etc., and have little change of color due to the sunlight rays, and where after their adhesion to the window glass their separation is easy and without residual adhesive.

In Japanese Patent Application Laid Open Number Hei-Sei 10-250004, a window adhesion film has been reported that is obtained as on one surface of a biaxially oriented polyester film a surface coating layer is formed, which contains a coating layer forming resin containing as its main components an acrylic resin (A) and a saturated polyester type resin (B), and also containing an ultraviolet rays absorbing agent (C) in an amount in the range of 5-40 weight parts relative to 100 weight parts of the above coated layer forming resin, and where on the other surface an adhesive agent layer is formed.

In Japanese Patent Application Laid Open Number 2000-96009, a laminated layer window adhesion film has been reported that is characterized by the fact that it is a laminated layer film where on at least one surface of a plastic film (A), an adhesive agent layer (B) has been provided, and at the time when the surface of the adhesive agent layer side of the above laminated layer film is adhered onto a glass plate, the properties are according to the below:
(1) The normal state adhesive force is at least 300 g/cm or higher.
(2) The extension when the holding strength is measured under conditions of a load of 1 kg and a temperature of 80° C., after a period of 1 hour is 3 mm or less.
(3) The adhesive strength when measured after a sustaining period of 6 hours after gluing onto a glass plate after immersion in water, is at least 20 of the normal state adhesive strength or higher.
(4) The residual amount of adhesive agent adhered onto the glass plate and with a size of 1 mm square or more at the time of separation after adhesion onto a glass plate and holding at a temperature of 70° C. for a period of 1 week is no more than 1 per 100 cm2 or less.

In Japanese Patent Application Laid Open Number 2000-117918, the heat ray reflective film for outdoor applications has been reported, which is characterized by the fact that it is a laminated layer film obtained as a weather resistant properties possessing biaxially oriented polyester film is used as the substrate material (A), and on at least one surface of the above substrate material, a heat rays reflecting layer (B) and a front surface protective layer (C) have been provided, and the visible light beam transmittance of the above film is at least 50% or higher and its near infrared ray reflectance is at least 50% or higher, and also, its haze value is 5% or less.

In Japanese Patent Application Laid Open Number 2000-183742, a window adhesion laminated layer film has been reported, which contains a plastic film layer and a silicone rubber layer that has a surface adhering to the window.

### SUMMARY

According to the above described, the window glass adhering film is a material that has the capability of preventing the window glass scattering and in the case of such material it is a material that has sufficient adhesive strength relative to the window glass and because of that it is not possible to be separated from the glass, or it can only be removed by using special solvent agents or tools etc., and thus its handling is difficult.

Also, there are cases where instead of the adhesive or bonding agent, the film has been adhered onto the window glass by using silicone rubber layer, however, even in these cases, under specific conditions of the temperature, temperature increase and decrease rate etc., of the window, which is the cover surface and the laminated layer film, accompanying the season, irradiation and temperature variations, there are cases where circumstances are generated such that due to excessive adhesion it is not possible to easily separate the adhesive layer or the film body itself.

The present disclosure provides a window adhesion laminated layer film that is a film that can be easily adhered especially on buildings etc., windows even by normal consumers who are not professionals etc., and that is a film where at the time of the adhesion entrapped air bubbles may be readily eliminated, and then, it is a laminated layer film, which even in the cases where it has been subjected to severe, long time sunlight radiation and/or temperature changes, does not generate excessive adhesion and has high weather resistant properties.

To overcome the above stated shortcomings, the present disclosure provides a laminated layer film that has an excess adhesion relief layer. More particularly, in one aspect, the present disclosure provides a window adhesion laminated layer film that comprises a plastic film layer, a silicone rubber layer and an excess adhesion relief layer that is on the surface of the above described silicone rubber layer.

In another aspect, a window is suggested where on at least one surface of the window a silicone rubber layer is layer laminated with an excess adhesion relief layer in between, and especially, at least a plastic film layer is layer laminated.

In yet another aspect, a manufacturing method for the window adhesion laminated layer film is suggested, which method comprises the technological process whereby the window adhesion laminated layer film, which contains the plastic film layer and the silicone rubber layer, is prepared, and the technological process, whereby on the above described silicone rubber layer the excess adhesion relief layer is formed.

According to one embodiment, the method of the application of the window adhesion laminated layer film onto the window is suggested, which comprises the technological process whereby on the window, the excess adhesion relief agent is applied, and the technological process where on the above described window the window adhesion laminated layer film, which contains a plastic film layer and a silicone rubber layer, which has a surface that adheres onto the window, is adhered.

In the case of the laminated layer film, the silicone rubber layer inside the laminated layer film is adhered onto the window with the excess adhesion relief layer being in between, and because of that there is no generation of excess adhesion of the silicone rubber layer and it can be easily separated from the window. Then, it is possible to obtain a laminated layer film where even in the cases when the laminated layer film has been subjected to conditions of sunlight radiation and temperature changes etc., there is no generation of excess adhesion.

### BRIEF DESCRIPTION OF THE DRAWINGS

FIG. 1 shows a laminated layer film according to one embodiment of the present invention where there is a plastic film layer and on top of that a silicone rubber layer on which surface there is an excess adhesion relief layer.

FIG. 2 shows a window where on one surface of the window there is a silicone rubber layer that is layer laminated with an excess adhesion relief layer in between, and then, at least one plastic film layer is layer laminated.

FIG. 3 shows the state where on a window an excess adhesion relief agent is applied and then on the top of that a window adhesion laminated layer film comprised of a plastic film layer and a silicone rubber layer, which has a surface that adheres onto the window, has been applied (b) and the state before that (a).

### DETAILED DESCRIPTION

Here below, a detailed disclosure will be provided of representative practical implementation conditions of certain embodiments of the present invention shown as examples, however, the present invention is by no means limited by these practical implementation conditions.

According to one embodiment, the present invention window adhesion laminated layer film is a film that contains a plastic film layer and a layer laminated on one surface of this plastic film layer, silicone rubber layer, and an excess adhesion relief layer provided on the top of the silicone rubber layer.

The laminated layer film contains an excess adhesion relief layer and because of that even if air bubbles are generated at the time of the adhesion, through, for example, a light squeegee action, it is possible to easily remove the air bubbles. Then, it is also possible to obtain a laminated layer film where at the time of the separation from the window, also, because of the fact that the laminated layer film contains an excess adhesion relief layer, there is no generation of excess adhesion of the silicone rubber layer and it is easily separated from the window.

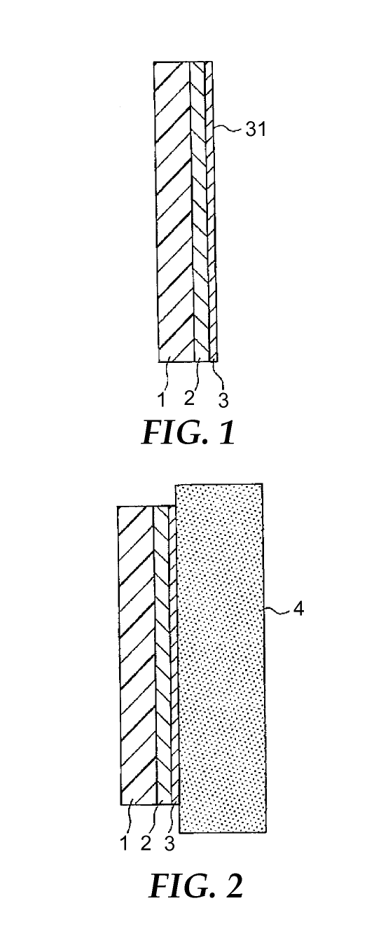

In FIG. 1 a cross sectional view of the window adhesion laminated layer film according to one embodiment of the present invention is shown. On one surface of the plastic film layer 1, the silicone rubber layer 2 is layer laminated and then, on the surface of the silicone rubber layer 2 the layer laminated excess adhesion relief layer 3 can be adhered on the window with the excess adhesion relief layer's adhesive surface 31 in between.

In FIG. 2 a cross sectional view diagram is shown of a window with a layer laminated window adhesion layer laminated film according to the present invention. On one surface of the window the silicone rubber layer 2 is layer laminated with the excess adhesion relief layer 3 in between, and then at least a plastic film layer 1 is layer laminated.

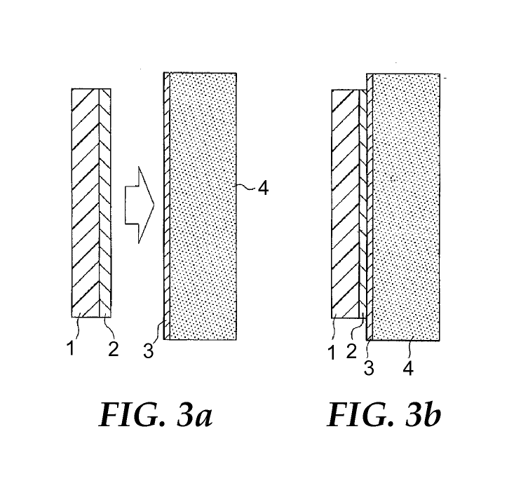

In FIG. 3, the condition is shown where after the technological process where on a window an excess adhesion relief agent is applied then on top of that a window adhesion laminated layer film is adhered, which contains a plastic film layer and a silicone rubber layer, which has a surface that adheres onto the window.

Then, in the case when the layer laminated film contains a plastic film and a silicone rubber layer on the surface of that and it does not contain an excess adhesion relief layer, it is possible that an excess adhesion relief layer be formed on one surface of the window and then after that the silicone rubber layer's adhesive surface is adhered.

As used in the detailed description the shown below terms have the shown below corresponding definitions.

The term “adhesion” means adhesion or bonding where the adhering material becomes one body with the material subject to the adhesion so it cannot be separated.

The term “excess adhesion” means a degree of adhesion onto the material subject to the adhesion where in the case when in order to separate the adhesive material (for example, silicone rubber layer) from the material subject to the adhesion (for example, window), it is possible to visually confirm adhesive material residue or adhesive traces or cohesive failure.

The term “bonding” can mean pressure sensitive adhesion and it can also mean adhesion.

The term “adhesion imparting agent” means a material that can be added into the silicone rubber layer in order to increase the properties of complying to the micro surface of the window and to increase the anchoring effect through decreasing the elastic modulus at room temperature.

The term “window” means a plate that has a thickness and that is made from glass, plastic etc.

The term “transparent” means a material that has a light beam transmittance of at least 80% or higher relative to the visible light beam, namely, relative to the wavelength region in the range of 380 nm˜780 nm.

The term “excess adhesion relief agent” means a compound or mixtures containing such compound, which through its positioning between the adhesive material and the material subject to the adhesion, decreases the excess adhesive properties of the adhesive material towards the material subject to the adhesion. The excess adhesion relief agent, at room temperature, can be a liquid material or a solid material, and through a solvent medium and/or dispersing medium and/or diluting medium, it can be made into a solution and/or a dispersion and/or a diluted material. Moreover, in the case when the excess adhesion relief agent is a liquid material, from a stable use stand point, it is desirable that relative to the whole amount of the excess adhesion relief agent, volatile liquid is used in an amount so that at approximately 150° C. for approximately 24 hours, only 50 weight % or less are volatilized; and also, so that at normal (room) temperature, there is no evaporation.

The term “excess adhesion relief layer” means a layer that is formed by the application of an excess adhesion relief agent on the top of the material subject to the adhesion like a window and/or a silicone rubber layer etc., and in the case when a solvent medium etc., is contained, it can be a layer where the solvent medium etc., cannot be completely removed or that the solvent medium etc., is partially or completely removed.

The term “surface active agent” means a material that contains in its molecule a hydrophilic radical and a hydrophobic radical.

There are no particular limitations regarding the materials that can be used as the excess adhesion relief agent as long as they satisfy the requirements that they are materials where even through ultraviolet light radiation, temperature variation, etc., in the beginning and after the passing of time, there are no detrimental effects on the laminated layer film's light beam transmittance, appearance, etc., parameters that can be visually observed, and there are no changes incurred with respect to the appearance, viscosity, homogeneousness, stability properties, etc., of the excess adhesion relief agent (here below, called necessary conditions of the excess adhesion relief agent); and it is possible to use any types of materials that under room temperature are liquid or mixtures containing them, or solutions and/or dispersions and/or diluted materials containing any type of these compounds or their mixtures.

In more details, as the excess adhesion relief agents, it is possible to use one or more types of naphtha components, paraffin, silicone oil etc., mineral oils, and corn oil, soy oil, sesame oil, rapeseed oil, coconut oil, etc., vegetable oils, mink oil, shark oil, etc., animal oils, paraffin type hydrocarbons, etc., natural oils, or mixtures thereof, and it is possible to satisfy the above described necessary conditions for the excess adhesion relief agent.

Then, as the excess adhesion relief agent, without particular limitations, among the (a) soaps (sodium—potassium salts of aliphatic acids), sodium esters of alpha sulfo aliphatic acids, etc., aliphatic acid type materials, linear chain alkyl benzene sulfonic acid sodium salts, etc., alkyl benzene sulfonic acid salts, alkyl sulfonic acid sodium esters, alkyl ether sulfonic acid sodium esters, monoalkyl sulfonic acid salts, etc., high homologous order alcohol type materials, alpha olefin sulfonic acid sodium salts, etc., olefin type compounds, alkyl sulfonic acid sodium salts, etc., normal paraffin type compounds, polyoxy alkylene alkyl ether sulfonic acid ester salts, alkyl polyoxy ethylene sulfonic acid salts, mono alkyl phosphoric acid salts, etc., anion type surface active agents, alkyl trimethyl ammonium salts, dialkyl dimethyl ammonium salts, alkyl benzyl dimethyl ammonium salts, etc., quarternary type ammonium salts etc., cationic type surface active agents, (b) alkyl amine oxide, alkyl dimethylamine oxide etc., alkyl amine oxide type compounds, alkyl carboxy betaine, alkyl hydroxy sulfobetaine, etc., betaine type compounds, alkyl amino aliphatic acid sodium salts, etc., amino acid type compounds, amphoteric surface active agents, (c) aliphatic acid sorbitane ester, cane sugar aliphatic acid ester sorbitane aliphatic acid esters, polyoxy ethylene sorbitane aliphatic acid esters, aliphatic acid alcanol amides, aliphatic acid diethanol amide, etc., aliphatic acid type compounds, alkyl (poly) gelkoside, polyoxy ethylene alkyl ethers, alkyl (mono) glyceryl ethers etc., high homologous order alcohol type compounds, polyoxy ethylene alkyl phenyl ethers etc., alkyl phenol type compounds, etc., non-ionic type surface active agents, etc., surface active agents that are well known to the persons skilled in the technology, the surface active agents or their solutions etc., are materials that satisfy the above described excess adhesion relief agent requirements and they can be widely used.

Regarding the excess adhesion relief agents according to the present invention, then, optionally (depending on the requirements), it is also possible to contain the well known by persons skilled in the technology additive agents like water, sulfuric acid salts etc., process agents, cumen sulfonic acid sodium salts, citric acid, citric acid tri sodium dehydrate compounds, benzoic acid sodium salts, ethyl alcohol, toluene sulfonic acid sodium salts, (poly) propylene glycol, (poly) ethylene glycol, polyoxy ethylene glyceryl ether, sodium chloride, potassium chloride, magnesium chloride, sodium sulfites, etc., stabilizing agents, ethyl alcohol, xantane gum, etc., viscosity regulating agents, alkoxylated polyethylene imine, etc., purification aiding agents, sodium hydroxide, citric acid, triethanol amine, etc., pH regulating agents, styrene—methacrylic acid copolymers, etc., emulsification agents, DTPA salts, citric acid salts, etc., water softening agents, polyacrylic acid sodium salts etc., agents preventing re-adhesion, silicone, etc., foaming regulating agents, carboxylic acid salts, silicic acid salts, etc., alkali agents, TAED etc., bleaching activation agents, sodium percarbonates, etc., bleaching agents, poly-acetic acid vinyl emulsion, etc., emulsifying agents, sulfuric acid zinc salts, etc., anti-bacterial agents, fragrance materials, antiseptic materials coloring materials, enzymes, etc.

As the solvent medium, dispersing medium, diluting medium for the excess adhesion relief agent, it is possible to use the materials that are well known to the persons skilled in the technology like water, ethyl alcohol, etc., alcohols, diethyl ethers, etc., ethers, ethyl acetate, etc., esters, methyl ethyl ketone, etc., ketones, toluene, etc., aromatic type compounds, hexane, etc., olefin type compounds, silicone oil, etc., and there are no particular limitations.

From the view point of the environmental properties, the safety properties, the impact towards humans, and the cost, water and alcohols are preferred. In the case when the excess adhesion relief agent contains a surface active agent, at the time of the application, there are no particular limitations relative to the amount of the surface active agent contained in the excess adhesion relief agent as long as there is no generation of white suspension in the solution etc., and in the total solution containing the solvent medium, etc., additives, etc., it can be contained in an amount of approximately 0.0025 w t % or higher, approximately 0.005 wt % or higher, approximately 0.0125 wt % or higher, and also approximately 0.25 wt % or less, approximately 0.125 wt % or less, approximately 0.05 wt % or less.

Typically, in the case when a solvent medium etc., is contained, after the drying, the dissolved material is close to 100 wt %.

As the method for the formation of the excess adhesion relief layer on the surface of the silicone rubber layer, it is possible to use any of the well known methods, and for example, it is possible to use the rod coating method, the conma knife method, the roll coating method, the blade coating method, the spray coating method, the air knife coating method, the dip coating method, the kiss coating method, the bar coating method, the die coating method, the reverse roll coating method, the offset gravure coating method, the Meyer bar coating method, the gravure coating method, the reverse gravure coating method, the roll brush method, the spray coat method, the spin coat method, and the curtain coat method, the brush coating, the drip etc., and these can be used individually or in combination.

In the case when there is an excess adhesion relief layer on the surface of the silicone rubber layer, it is possible to use the spray coating method, the bar coating method, the brush coating method, the drip down method etc., methods individually or in a combination as the method whereby an excess adhesion relief layer is provided on the surface of the window.

Optionally (depending on the requirements), it is also possible to provide excess adhesion relief layers on both the surface of the silicone rubber layer and on the window).

Then, it is also a good option if on the surface of the below described protective sheet an excess adhesion relief layer is formed and at the time when it is then layer laminated with a silicone rubber layer, which does not contain an excess adhesion relief layer, this excess adhesion relief layer is transferred.

Also, it is a good option if the excess adhesion relief layer is applied on the whole surface of the adhesive material, the material subject to the adhesion, or the protective sheet, or if it is applied on one part of that surface.

As the thickness of the excess adhesion relief layer it is possible to use any thickness as long as after the adhesion there is no generation of separation caused by its own weight, etc., or generation of excess soiling etc., on the material subject to the adhesion caused by the excess weight etc., and for example, it is also possible to use a molecular level thickness, etc.

Also, regarding the laminated layer film used, it is possible to be a material that is formed as at the time of the manufacturing of the silicone rubber layer, inside the silicone rubber layer, an excess adhesion relief agent is held and with the passing of the time it bleeds to the front surface of the silicone rubber layer that is on the opposite side of the plastic layer, so that the excess adhesion relief layer is formed. In that case, it becomes a structure where the laminated layer film does not have an excess adhesion relief layer in the beginning of the manufacturing; however, with the passing of the time, an excess adhesion relief layer appears on the surface of the silicone rubber layer.

Or, it is also a good option if a structure is obtained where immediately after the manufacturing, there is an excess adhesion relief agent inside the silicone rubber layer, and also, on the front surface of the silicone rubber layer there is an excess adhesion relief layer.

As the excess adhesion relief agent that is held inside the silicone rubber layer, it is also possible to use the materials that have been described here above as excess adhesion relief agents.

Also, as the excess adhesion relief agent it is possible to use materials that have a structure that is similar to the silicon skeleton inside the silicon rubber layer, definitely materials that do not contain radicals that react with the silicone skeleton, or materials that contain components where with the passing of the time through ultraviolet light, heat, etc., the bond breaks and they transfer to the surface of the silicone rubber layer.

Then, as the excess adhesion relief agent, it is also possible to use materials that not only have a silicone skeleton, but also among the described in the above detailed description adhesion imparting agents, or excess adhesion relief agents or additive agents, or solvents inside the silicone rubber layer, etc., the materials that satisfy the above described excess adhesion relief agent necessary conditions, can be used by for example, as at the time of the formation of the silicone rubber layer, they are being held in an excess amount inside the silicone rubber layer.

At the time when the excess adhesion relief agent is being held inside the silicone rubber layer, optionally it is also possible that the above described solvent medium, dispersing medium, diluting medium, are used with the goal of increasing the processing ability properties, and the homogeneousness inside the layer.

There are no particular limitations regarding the layer used as the silicone rubber layer, and it is possible to use the layers that are a common knowledge. Especially, as the silicone rubber layer, as described here below, if layers are used that are obtained as a silicone main agent containing reactive polydimethyl siloxane, etc., and a crosslinking agent are mixed and under the presence of a catalyst they are cured on the surface of the plastic film layer, it is possible to easily obtain silicone rubber layers where the adhesive strength between the plastic film layer and the silicone rubber layer becomes sufficient. Regarding the combinations of the silicone main agent, the crosslinking agent and the catalyst, there are the following three types: (i) the condensation type (wet curing type) where as the silicone main agent, end hydroxyl radicals containing polydimethyl siloxane and/or polydimethyl siloxane and polydiphenyl siloxane copolymers, etc., are used, as the crosslinking agent, poly-functional —Si(OCH3)3 type crosslinking agent, etc., are used, and as the catalyst, dibutyl lead dilaurate, etc., are used; (ii) the adduct type, where as the silicone main agent vinyl radical containing polydimethyl siloxane and/or polydimethyl siloxane and polydiphenyl siloxane copolymers, etc., are used, as crosslinking agents, Si—H containing siloxane type crosslinking agents, etc., are used, and as catalyst, platinum catalysts, etc., are used; and (iii) the silicone polyurea type, where as the silicone main agent end amine radicals containing polydimethyl siloxane and/or polydimethyl siloxane and polydiphenyl siloxane copolymers, etc., are used, as the crosslinking agent, polyisocyanate radical containing crosslinking agents, are used, and as the catalyst, dibutyl lead dilaurate, etc., are used.

There are no particular limitations regarding the weight average molecular weight of the silicone main agent, and it can be approximately at least 50,000 or higher, approximately at least 100,000, or higher, approximately at least 200,000, and approximately at least 300,000 or higher, and also approximately 2,000,000 or less, approximately 1,000,000 or less, approximately 500,000 or less, and approximately 400,000 or less. Regarding the weight average molecular weight of the silicone main agent, if it is approximately 300,000 or higher and approximately 500,000 or lower, it is easy to use and that is why it is preferred.

Regarding the mole amount of the crosslinking agent that is used relative to the reactive radical in 1 mole of the main silicone agent, namely, for example, in the case of the condensation type, the end hydroxyl radical, in the case of the adduct type, the vinyl radical and in the case of the silicone polyurea type, the end amino radical, there are no particular limitations as long as it does not hinder the adhesive properties after the curing, however, it is possible to be approximately 0.5 or higher, approximately 1.0 or higher, approximately 1.5 or higher and approximately 3.0 or less, approximately 2.0 or less.

Regarding the mole amount of the crosslinking agent relative to 1 mole of the main silicone agent, in the case of the condensation type or the adduct type, it is appropriate to be within the range of approximately 0.5˜approximately 3.0, so that after the curing there would be no residual unreacted main silicone agent or crosslinking agent, etc., and in the case of the silicone polyurea type, it is appropriate to be within the range of approximately 0.5˜approximately 1.5. Regarding the mole amount of the crosslinking agent relative to 1 mole of the main silicone agent, when it is approximately 1.0 it becomes the equivalent amount and that is a preferred amount.

The crosslinking degree between the main silicone agent and the crosslinking agent, as described here below, can be represented by the gel fraction of the silicone rubber layer after the curing.

Moreover, in the case when the silicone rubber layer contains the below described adhesion imparting agent, the contained amount of this adhesion imparting agent is not included in this gel fraction amount.

Regarding the gel fraction, it can be approximately 95% or higher, approximately 98% or higher, approximately 99% or higher, approximately 99.8% or higher, and if it is approximately 90% or higher, it is appropriate because after the separation there are almost no adhesive traces, etc., left on the surface of the window, and from the point of view of a level where there are no adhesive traces etc., at all observed on the window after the separation, if it is a level of approximately 99% or higher, it is a preferred option, and then, it is especially preferred if it is at least approximately 99.8% or higher.

In the crosslinking reaction between the main silicone agent and the crosslinking agent, optionally, it is also possible to use a catalyst. In that case, the amount of the catalyst relative to the main silicone agent and the crosslinking agent, in the case of the condensation type or the silicone polyurea type, by weight, can be approximately 0.0001% or higher, approximately 0.00015% or higher, approximately 0.001% or higher, and approximately 3.0% or less, approximately 2.0% or less, and approximately 1.0% or less; and in the case of the adduct type, by weight, it can be approximately 100 ppm or less, approximately 90 ppm or less, approximately 80 ppm or less.

Regarding the amount of catalyst relative to the main silicone agent and the crosslinking agent, when it is, by weight, in the case of the condensation type or the silicone polyurea type in the range of 0.0001˜3.0% and in the case of the adduct type, in the range of 1˜100 ppm, the reaction proceeds sufficiently and there is no variation in the time it takes, and after the curing there is no deterioration of the properties of the silicone rubber layer, and because of that the above ranges are preferred.

There are no particular limitations regarding the thickness of the silicone rubber layer, and the thickness after the curing can be approximately 40 microns or less, approximately 30 microns or less, approximately 25 microns or less, approximately 20 microns or less, approximately 15 microns or less, approximately 10 microns or less, and also approximately 0.3 microns or more, approximately 0.5 microns or more, approximately 0.7 microns or more, approximately 1.0 microns or more, approximately 2.0 microns or more. Regarding the thickness of the silicone rubber layer, if it is too thin, it becomes difficult for it to be adhered directly or through the excess adhesion relief layer onto the material subject to the adhesion, and because of that it is preferred if it is at least 0.5 microns or higher, and then it is even more preferable if it is at least 1.0 micron or higher.

Then, regarding the thickness of the silicone rubber layer, from an economical viewpoint, it is appropriate if it is 30 microns or less, and it is then even more preferred if it is 20 microns or less.

Regarding the silicone rubber layer, fundamentally, it does not contain other additive agents, etc., however, optionally, it is also possible to be a layer that contains additive agents etc., that are described below in the paragraphs regarding the plastic film layer and the metal layer.

Regarding the silicone rubber layer according to the present invention, it practically does not contain the adhesion imparting agents known by the persons skilled in the industry, namely, for example, the materials that are used in order to comply to the micro surface of the window and increase the anchoring effect through lowering the elastic modulus at room temperature.

However, as long as the weather resistance properties and the adhesion properties, etc., of the silicone rubber layer are not deteriorated, there are no particular limitations and the generally used adhesion imparting agents can be added. In more details, as the adhesion imparting agents, for example, it is possible to use MQ resins.

Regarding the MQ resins, for example it is possible to use the resins that are solid state resins that have in the molecule the R3SiO— (M body) and the SiO4- (Q body) structure, and usually, their weight average molecular weight is in the range of 10,000˜150,000, and where the M body is in the range of 0.7˜1.1 moles relative to 1 mole of the Q body. They can be used as they are mixed and dissolved into the main silicone agent, etc., and after that they are cured.

Regarding the silicone rubber layer according to the present invention, an adhesion imparting agent can be contained in an amount, by weight, that is approximately 15% or less, approximately 10% or less, approximately 5% or less and is approximately 0.1% or more, approximately 1% or higher. Moreover, regarding commercially available normal use adhesion imparting agents, usually, the materials are known that contain an MQ resin, etc., adhesion imparting agent in an amount of at least 50 weight % or more.

Regarding the silicone rubber layer, even in the case when it contains an adhesion imparting agent and/or an excess adhesion relief agent, the thickness and the adhesion strength etc., of the silicone rubber layer can be adjusted to be within the range of the above described silicone rubber layer that does not contain adhesion imparting agent.

Regarding the silicone rubber layer, even in the case when it contains an adhesion imparting agent and/or an excess adhesion relief agent, as the method of use of the silicone solution containing the main silicone agent, the crosslinking agent, the catalyst, the adhesion imparting agent, the excess adhesion relief agent, any of the well known methods that have been described for use for the above described excess adhesion relief layer, can be used individually or in a combination.

There are no particular limitations regarding the material used as the material of the plastic film layer according to the present invention, and for example, it is possible to use films that are formed from polyester, polyamide, polyolefin, polyvinyl chloride, polycarbonate, acrylic type resins, fluorinated type resins, etc.

Also, regarding the structure of the plastic film layer, optionally (depending on the requirements), it is also a good option if it is formed as a multi-layer structure that contains any number of layers and that is formed through co-extrusion, with the goal of adjusting the reflectivity or the permeability.

Among these, from the view point of the transparency properties, the dimensional stability properties and the economical properties, etc., polyester, polycarbonate, acrylic type resins, and polyolefins, are preferred. Then, especially, from the point of view of the transparency properties, the economical properties, the weather resistant properties, the heat resistant properties, the mechanical properties, etc., the polyester films are preferred. In the case of polyester films, there are no particular limitations and in correspondence with the intended application, it is possible to use uniaxially oriented polyester films, biaxially oriented polyester films, or non-oriented polyester films, etc.

Regarding the thickness of the plastic film layer, there are no particular limitations as long as there are no problems with respect to the flexibility properties, etc., and it is possible to use materials with a thickness of approximately 200 microns or less, approximately 100 microns or less, approximately 50 microns or less, and approximately 10 microns or more, approximately 20 microns or more, approximately 30 microns or more. Regarding the thickness of the plastic film layer, if it is approximately 30 microns or more and approximately 100 or less, at the time of the adhesion onto the window the handling becomes easy and that is why it is a preferred range.

Regarding the plastic film layer, then, optionally (depending on the requirements), there are no particular limitations and it is possible to be a material that contains anti-electrostatic agents, stabilizing agents, lubricating agents, crosslinking agents, blocking prevention agents, anti-oxidation agents, ultra-violet ray absorption agents, infrared ray absorption agents, light beam interception agents, coloring agents used in order to provide design, etc., lubricating agents that are used in order to improve the handling at the time of the vapor deposition, etc., processing, etc.

Through the plastic film layer, for example, by using an infrared rays absorbing agent and an ultraviolet ray absorbing agent together, it is possible to decrease the transmittance of the ultraviolet rays and the infrared rays without decreasing the transmittance of the visible light rays.

Then, for example, if a plastic film layer with a multi-layer structure that selectively absorbs the light in the near infrared ray region and an infrared ray absorbing agent and an ultraviolet ray absorbing agent are combined, it is also possible to obtain a material where the transmittance of the infrared rays and the ultraviolet rays is decreased without a decrease of the transmittance of the visible light.

Regarding the plastic film layer, it is also possible to be a layer where on at least one surface side a metal layer and/or metal compound layer is provided with the goal of reflecting the ultraviolet rays, the infrared rays, the visible light rays, etc. If a metal layer is used, for the whole range from the infrared rays to the ultraviolet rays, the transmittance becomes flat, and because of the fact that it is a general knowledge how to achieve absorption for a specific wavelength, etc., depending on the intended applications, for example, a wide range of metal layers can be used. As the metal compounds that form the structure of the metal layer, it is possible to use Au, Ag, Cu, Al, etc., metals or alloys. From the point of view of the cost and the reflectance, Al or its alloys are preferred. As metal compounds forming the structure of the metal layer, besides the above, the generally known ITO (material where several % of tin oxide is mixed into indium oxide), etc., can also be used. Moreover, depending on the requirements it is also possible to use 2 or more types of metal compounds.

Also, on the surface of the metal layer that is opposite to the plastic film layer side, it is also a good option if an anti-corrosion coating layer is provided with the goal of preventing the oxidation of the metal layer.

Regarding the light beam transmittance of the metal layer, it can be approximately 1% or higher, approximately 5% or higher, and approximately 75% or less, approximately 70% or less, approximately 65% or less, and usually, materials where the average value is within the range of 5%˜20% are widely used, however, there are also cases where it is appropriate that these are in the range of 35%˜65%.

Regarding the laminated layer film, then, with the goal of increasing the bonding strength between the metal layer and the silicone rubber layer, and protecting the metal layer from corrosion, it is possible to provide a coating layer in the space between the metal layer and the silicone rubber layer.

Also, in order to improve the appropriate use properties or the bonding properties, etc., of the plastic film layer, it is also a good option if prior to the use, a chemical treatment or corona discharge treatment is applied to the plastic film layer.

Regarding the plastic film layer, then, optionally (depending on the requirements), there are no particular limitations and it is possible to be a material that contains anti-electrostatic agents, stabilizing agents, lubricating agents, crosslinking agents, blocking prevention agents, anti-oxidation agents, ultra-violet ray absorption agents, infrared ray absorption agents, light beam interception agents, coloring agents used in order to provide design, etc., lubricating agents that are used in order to improve the handling at the time of the vapor deposition, etc., processing, etc.

Regarding the laminated layer film, for example, with a decoration goal, it is possible that it contains a single layer or a multi-layer printing layer on the side of the silicone rubber layer on the surface of the plastic film layer and/or on its opposite side. Regarding the printing layer, for example, it is appropriate if it is positioned in the space between the plastic and the metal layer, so that there is little color fading caused by rubbing etc.

On the contrary, if a printing layer is provided on the surface of the side opposite to the silicone rubber layer, for example, it is possible to conduct printing immediately prior to the adhesion of the laminated layer film onto the window, and it becomes possible to conduct a timely, public notice, product price etc., independent printing and decoration.

Also, it is a good option if instead of printing on the surface of the plastic film layer, a coloring agent is contained so that nice pattern, etc., is formed inside the plastic film layer.

Regarding the laminated layer film, excluding the case where a coloring agent etc., is contained, they are films where the whole body of the laminated layer film has visible light ray transmittances that are approximately 10% or higher, approximately 30% or higher, approximately 40% or higher, and it has visible light ray transmittances that are approximately 99.9% or less, approximately 90% or less, approximately 80% or less, approximately 60% or less.

Regarding the laminated layer film, it is possible to be a film that contains a coating layer in the space between the silicone rubber layer and the plastic layer, etc., with the goal to increase the bonding strength between the silicone rubber and the plastic layer, etc.

Also, in order to improve the compatibility or the bonding properties of the silicone rubber layer relative to the plastic film layer etc., it is also a good option if prior to the use the plastic film layer, etc., is subjected to a flame treatment, a corona discharge treatment, a plasma discharge treatment, etc., physical surface treatments, or a primer, etc., chemical treatments.

In order to increase the scratch resistant properties and/or the stain resistant properties of the top surface of the laminated layer film, on the top most surface of the plastic film layer or on the surface of the printed layer, etc., of the plastic film layer, it is possible to provide a scratch resistant layer and/or a stain resistant layer. As the resin material that forms the structure of the scratch resistant layer and/or a stain resistant layer, for example, it is possible to appropriately use the same methods, etc., as the below described methods for the silicone rubber layer, and it is possible to use excellent weather resistant properties possessing, thermoplastic resins or thermo curing resins, etc. As such resins, for example, it is possible to use fluorine containing resins, acrylic resins, polyvinyl alcohol resins, epoxy resins, unsaturated polyester resins, urethane resins, melamine resins, silicone resins, and acryl—silicone resins, etc.

Regarding the scratch resistant layer and/or a stain resistant layer, instead of being provided depending on the intended application, it is also possible that a plastic film layer be used that has an applied in advance onto the front surface scratch resistant layer and/or a stain resistant layer.

Regarding the protection state of the window use film, it is possible to use a material that has a protective sheet, etc., in order that the adhesive surfaces of the silicone rubber layer's adhesive surface or in the case when there is a excess adhesion relief layer, the adhesion surface of the excess adhesion relief layer, are protected so that it is difficult to be scratched or for dust etc., to adhere.

As the protective sheet it is possible to use sold on the market as normal products PET, PP etc.

that have a thickness, which does not generate problems with respect to the flexibility properties and there are no particular limitations.

In the case of a laminated layer film where numerous pierced holes are provided that pierce through from the top surface of the below described laminated layer film˜adhesion surface, in order so that the protective sheet itself does not adhere, it is a good option even if the pierced holes are not present, or if it is a good condition for the processing it is a good option if the protective sheet is not pierced and also if pierced holes are present.

Also, in the case when an excess adhesion relief layer is separately formed on the window, or in the case when even though the laminated layer film contains an excess adhesion relief layer, there is no excess adhesion relief layer remaining on the top most surface of the laminated layer film, instead of using a protective sheet it is also possible that through winding the laminated layer film itself in a roll form, the top most surface of the plastic film layer etc., can be used as the protective sheet.

In the case of the laminated layer film according to the present invention, it is possible to be a material where after the formation of the laminated layer film, which is explained in details here below, numerous pierced holes are pierced from the top surface of the laminated layer film—to the adhesion surface.

At the time of the adhesion of the laminated layer film onto the material subject to the adhesion, it is possible that the air, water etc., that are enclosed and remain in the space adhesive surface of the laminated layer film and the material subject to the adhesion, are expelled through these pierced holes to the side of the top surface of the laminated layer film.

There are no particular limitations regarding the shape of the cross sectional plane of these pierced holes, and when viewed from the laminated layer film's top surface side or adhesive surface side, it is possible to have different types of shapes like correspondingly a circular shape, an oval shape, a square shape, a polyhedral shape, a star shape, etc., and also it is possible that the shape when viewed from the top surface side and the shape when viewed from the adhesive surface side become different, however, when the shape is circular and is the same when viewed from the top surface side and when viewed from the adhesive surface side, it is a preferred option as the manufacturing costs can be decreased.

### EXAMPLES

Gel Fraction Measurement: Under room temperature and room humidity, 0.5 grams of precisely weighted (denoted as W0 (g)) experimental sample is immersed in 200 cc of toluene for 24 hours, the toluene soluble component is dissolved from the experimental sample and after that the non dissolved part is separated and washed with acetone and dried and after that this non-dissolved component is dried for a period of 1 hour under a pressure of 0.1 MPa in a vacuum drying device that has been set at 100° C. (maker name: Yamato Materials Company, model name:DP32) and the weight of this non-dissolved component (denoted as W1 (g)) is precisely weighted, and the gel fraction is calculated according to the following formula:

Gel fraction (%)=(W1/W0)×100.

Material subject to the adhesion: According to this present practical implementation condition, a window glass with a size larger than the sample (dimensions: 120 mm square, thickness 3 mm, maker name: Asahi Glass Company; model name: FL3) was manually cleaned by using a sponge (maker name: Sumitomo 3M Company; model name: Sponge abrasive material 5082) and the dust, dirt, particles etc., on the surface of the glass were removed, and by using a paper towel (maker name: Nippon manufacturing paper Clayshea Company; model name: Kimu Wipe S-200), the water was wiped out and after that the material was used in the test.

Laminated Layer Film 1: On a laminated layer film, which has as the plastic film layer, a 50 micron thickness PET film (Lumilar—50S10 (Toray Company)), and on its surface has a silicone rubber layer with a thickness of 5 microns that has been obtained as a mixture containing main silicone agent (Toray Dow Corning Company), SD7226 (30 weight % solution of silicone resin in toluene), crosslinking agent containing catalyst used for silicone curing (Toray Dow Corning Company, SRX 212) in a corresponding ratio of 100:0.6 (as weight ratio) is cured, a protective sheet (30 micron thickness OPP (Toray Company, Torayfan 30-2500)) was provided on the silicone rubber layer surface, and the material was cut to dimensions of a length of 100 mm×width of 100 mm and that was used. The gel fraction was 95%.

Manufacturing of the Excess Adhesion Relief Agent

P&G Company manufactured product trade name: Joy, Lot Number: 008521124DC1853 was titrated into 400 ml of water and sufficiently stirred, and the excess adhesion relief agent was manufactured. The same way, by using Lion Company manufactured product trade name: Mamalemon, Lot Number: 5022344, Kao Company manufactured product trade name: Kyukyuto: W842860, the same way the excess adhesion relief agent, was manufactured. The composition of each of these mild cleaning agents and the results for these corresponding mild cleaning agents for 10 drops and the results from the 3 times weight measurements and their average, are shown in Table 1.

TABLE 1
Each mild cleaning agent composition and weight (g) per 10 drops.

| a. Composition | Joy | | Mama Lemon | | Kyukyuto | |
|---|---|---|---|---|---|---|
| Function/ | | Compounded | | Compounded | | Compounded |
| Compounding | Component | Amount | Component | Amount | Component | Amount |
| goal | Name | wt % | Name | wt % | Name | wt % |
| Surface Active Agent | Alkyl ether | 31 | Linear chain | 27 | Polyoxy | 45 |
| | sulfuric acid | | alkyl benzene | | alkylene alkyl | |
| | sodium ester, | | sulfonic acid | | ether sulfuric | |
| | alkyl amine | | sodium salt, | | acid sodium | |
| | oxide, | | linear chain | | ester, alkyl | |
| | polyoxy | | alkyl benzene | | hydroxy sulfo | |
| | ethylene | | sulfonic acid, | | betaine, | |
| | alkyl ether | | alkyl ether | | alkylamine | |
| | | | sulfuric acid | | oxide, alkyl | |
| | | | sodium ester | | glycoside, alkyl | |
| | | | | | glyceryl ether, | |
| | | | | | polyoxy | |
| | | | | | ethylene alkyl | |
| | | | | | ether | |
| Cleaning aid agent | Alkylated | | | | | |
| | polyethylene | | | | | |
| | imine | | | | | |
| Viscosity regulating | Ethyl alcohol | | | | | |
| agent | | | | | | |
| Stabilizing agent | Sodium | | Ethyl alcohol, | | Ethyl alcohol, | |
| | chloride | | sodium | | toluene sulfonic | |
| | | | benzoate, | | acid sodium | |
| | | | polyethylene | | salt, magnesium | |
| | | | glycol, citric | | chloride, | |
| | | | acid | | polypropylene | |
| | | | | | glycol, polyoxy | |
| | | | | | ethyleneglyceryl | |
| | | | | | ether, sodium | |
| | | | | | sulfite | |
| pH regulating agent | Sodium | | Triethanolamine | | Triethanolamine | |
| | hydroxide | | | | | |
| Process agent | Water | | Water | | Water | |
| Fragrance | Fragrance | | Fragrance | | Fragrance | |
| Anti-corrosion agent | Anti- | | | | | |
| | corrosion | | | | | |
| | agent | | | | | |
| Coloring agent | | | Coloring agent | | | |
| Anti-bacterial agent | | | | | Zinc sulfate | |
| b. weight (g) per 10 | 1 trial | 0.28 | 1 trial | 0.29 | 1 trial | 0.19 |
| drops | 2 trial | 0.24 | 2 trial | 0.30 | 2 trial | 0.18 |
| | 3 trial | 0.26 | 3 trial | 0.32 | 3 trial | 0.19 |
| | Average | 0.26 | Average value | 0.30 | Average value | 0.19 |
| | value | | | | | |

After that, as the excess adhesion relief agent the water solution of water and each of the mild cleaning agents, were used, and for the excess adhesion of the laminated layer film after a heat cycle, evaluation was conducted, regarding a) difference due to number of heat cycles, b) difference due to the added amount of the mild cleaning agent, and c) difference due to the type of the excess adhesion relief agent, and the results are shown in Table 2.

The conditions were according to the below described.

Material subject to the adhesion: window glass

Film used: laminate layer film 1

Application of the excess adhesion relief agent and application of the laminated layer film: Under room temperature and by using a commercial spraying device, spraying was performed from a distance of 20 cm from the material subject to the adhesion and by that the whole front surface of the material subject to the adhesion was provided with the excess adhesion relief agent evenly and without variations. After that the protective sheet of the laminated layer film was separated and the silicone rubber layer side of the laminated layer film was applied onto the material subject to the adhesion, and by using a squeegee (maker name: Sumitomo 3M company, model type: PA1-STD) relative to the whole surface of the laminated layer film, it was applied on the material subject to the adhesion cleanly and without air bubbles.

Amount of the mild cleaning agent: Regarding the shown in table 1 and 2 number of drops, these indicate the number of drops from each mild cleaning agent that are added into 400 ml of water. The mild cleaning agent is added into the water and after that it is covered and sufficiently stirred and after that it is used.

Heat cycle: The heat cycle is conducted as the samples are left for a period of 30 minutes each at 60° C. and after that at room temperature.

Evaluation Criteria for the Excess Adhesion

After the heat cycle, one corner of the laminated layer film is separated in a direction that is at a 90 degree angle relative to the flat surface of the material subject to the adhesion at a separation rate of 30 cm/minute, and a visual observation is conducted as to the presence or not of silicone rubber layer on the surface of the material subject to the adhesion, and in the case when there is a residue, its sample number is counted. In Table 2, the evaluation results denominator shows the total tested samples, and the numerator shows the number of samples among these where there was a silicone rubber layer residue on the surface of the material subject to the adhesion.

TABLE 2
Effects due to the heat cycle number, the added amount of the mild cleaning agent, the heat cycle
temperature and the type of the cleaning agent
a. Difference due to the number of heat cycles, X: 60

| | | | | | |
|---|---|---|---|---|---|
| Type of the excess | Cycle number | 0 | 2 | 5 | 10 |
| adhesion relief | Number | Reference Example 1 | Reference Example 2 | Reference Example 3 | Reference Example 4 |
| agent and | Water only | 0/4 | 3/5 | 5/8 | 3/4 |
| evaluation | Number | Example 1 | Example 2 | Example 3 | Example 4 |
| | Joy 10 drops | 0/4 | 0/4 | 0/4 | 0/4 |

b. Difference due to the amount added of the mild cleaning agent, X: 60, cycle numbers: 5

| | | | | | |
|---|---|---|---|---|---|
| Number | Example 5 | Example 6 | Example 7 | Example 8 | Example 9 |
| Number of drops | 1 | 3 | 5 | 10 | 40 |
| Evaluation | 1/8 | 0/8 | 0/8 | 0/8 | 0/8 |

c. Difference due to the type of the excess adhesion relief agent, 10 drops of the corresponding mild cleaning agent, cycle numbers: 5

| | | | | |
|---|---|---|---|---|
| Number | Reference Example 3 | Example 8 | Example 10 | Example 11 |
| Spraying solution | Water only | Joy | Mama Lemon | Kyukyu to |
| Evaluation | 5/8 | 0/8 | 0/8 | 0/8 |

As it is shown in a in the above Table 2, in the case of adhesion when only water is used, when 2 or more heat cycles are performed silicone rubber residue caused by the adhesion is observed (Reference Examples 1˜4), however, in the case when a mild cleaning agent water solution was used as an excess adhesion relief agent, even after 10 heat cycles there was no residue observed (Examples 1˜4).

As it is shown according to b in the above Table 2, with the exception of the 1 drop of the mild cleaning agent, the excess adhesion relief agent shows good results in all other examples (Examples 6˜9). Regarding the appearance, when more than 10 drops of the mild cleaning agent are added, it was visually observed that the applied to the material subject to the adhesion excess adhesion relief layer becomes milky and hazy, however when that amount is in the range of 5˜10 drops, there was no haziness observed and then, at the time when the laminated layer film was adhered, quietly and smoothly the squeegee operation was conducted.

Then, as it is shown according to c in the above Table 2, regarding the excess adhesion relief agent, irrespective of the type of the mild cleaning agent, good results were obtained (Examples 8, 10 and 11).

As it has become clear from the above described, in the case of the shown in the examples practical implementation conditions, the window adhesion laminated layer film containing an excess adhesion relief layer can be easily adhered onto the window and then even in the case when it is subjected to particular conditions like temperature changes, etc., it has good adhesion and separation properties and not only that but also even after it is separated there is no silicone rubber layer residue or adhesive traces or cohesive failure, namely there is no generation of excess adhesion and it yields excellent results.

1. Window adhesion laminated layer film, comprising:
a plastic film layer,
a silicone rubber layer, and
an excess adhesion relief layer that is on the surface of the silicone rubber layer.)

2. A window wherein at least one surface of the window a silicone rubber layer is layer laminated with an intermediary of an excess adhesion relief layer and at least one plastic film layer.)

3. (canceled)

4. A method for the application of a window adhesion laminated layer film comprising
a technological process where an excess adhesion relief agent is provided on a window, and
a technological process where on the above described window, a window adhesion laminated layer film, which contains a plastic film layer and a silicone rubber layer that has a surface that adheres onto the window, is adhered.
